(19) United States
(12) Patent Application Publication
(10) Pub. No.: US 2002/0013713 A1
(43) Pub. Date: Jan. 31, 2002

(54) Method for realizing burning candle on internet space

(76) Inventors: Dong Wook Shin, Seongnam-si (KR); Sung Chul Lee, Cheonan-si (KR)

Correspondence Address: JACOBSON HOLMAN PLLC, 400 SEVENTH STREET N.W., SUITE 600, WASHINGTON, DC, 20004, US

(21) Appl. No.: 09/891,417

(22) Filed: Jun. 27, 2001

(30) Foreign Application Priority Data
Jul. 13, 2000 (KR) 2000-40216

(51) Int. Cl. G06F 17/60

(52) U.S. Cl. 705/1; 705/26

(57) ABSTRACT

Provided is a method for realizing a burning candle on the Internet space, comprising the steps of a) transmitting a web page to a user so that the user can select the kind and pattern of a candle and input data including the opening and closing dates of the candle, b) generating a database based on the user's input data, c) extracting a candle corresponding the database and transmitting the candle to the user, d) lighting the candle, e) burning down the candle as time elapses, and f) extinguishing the candle. In the method for realizing a burning candle on the Internet space, candles incarnating hope or desire are purchased with payment, rather than free of charge, thereby creating revenues based on the sales of the candles, solving the revenue problem with existing electronic businesses. Also, for a user who wants to pray for his/her earnest hope or intention but has no time to visit a place where votive candles are provided, a praying-purpose candle can be realized on the Internet. Further, the votive candle can be lit for the good of others and one can also identify that the candle is lit for one's own sake, thereby generating emotional ties between the prayer and the subject of prayer through interaction over the Internet, touching the moderns and giving them comfort or consolation.

### BACKGROUND OF THE INVENTION

1. Field of the Invention

The present invention relates to a method for realizing burning candles on the Internet space.

2. Description of the Related Art

Traditionally, candles have been lit for various votive and praying purposes. While praying with a candle remaining lit, people are often put their mind at rest by a placebo effect. However, since such votive candles are typically lit in remote temples, it is quite cumbersome for the moderns who are always pressed for time to specially visit a remote place for votive ceremonies. Even if candles can be lit at home, this suffers from the exposure to serious fire hazards because they usually remain lit overnight.

### SUMMARY OF THE INVENTION

To solve the above problem and to allow more people to pray for hopes or special intentions of themselves or others in a more convenient and safe manner, the present invention provides a method for realizing burning candles on the Internet space. In other words, the main object of the present invention is to provide a method of lighting and managing candles on the Internet space for various praying, celebrating or soliciting purposes.

The basic concept of the present invention is that candles incarnating hope or desire are purchased with payment and lit in cyber space. If one is not wholehearted in taking care of the candle, that is, if one does not visit the cyber space where the candle remains lit, for a while, the candle is extinguished by a virtual gale. To avoid this, one must constantly manage the candle.

According to the present invention, since candles to be lit in cyber space must be paid to purchase, rather than free of charge, the inventive model can serve as a profitable business model, from the viewpoint of revenue, which has been a subject of argument for existing e-businesses. Also, since people frequently visit web sites where transactions of candles occur, for constantly managing and taking care of the candle, the revenue associated existing e-business models can be maintained. Further, numerous kinds of human hopes or wishes can be grouped into several categories for the systematic management according to like-categorized users, e.g., high-school students, workers, admirers of a popular entertainer(s) or supporters of a specific political party. Thus, differential advertisements can be invited. The returns from the sale of candles can be used to realize users' actual hopes. That is to say, mutual help among people and contribution to social welfare or public service can also be achieved.

An essential feature associated with the present invention is that a candle is burnt for a fixed period. Whenever one who intends to see the candle, not necessarily the person who lit the candle at first, visits a place where the candle remains lit, that is, a designated uniform resource locator (URL), the visiting time is represented in percentile (%) of candle burning time relative to total duration of the candle by means of a server and the length of the candle is adjusted according to the percentile and shown to the visitor. Thus, it seems to the visitor that the candle keeps burning. This makes no difference from the effect of visiting a place where an actually burning candle is lit for a fixed period, except for the warmth of the candle.

Another essential feature associated with the present invention is that the candle is extinguished if a user is not wholehearted in taking care of the candle, that is, if the candle is not visited for a few days. The manifestation of wholeheartedness may be initially determined by user or imposed by site operator. If predetermined conditions, e.g., visit frequency, are not satisfied, demerit marks are automatically given. Then, the intensity of a gale is adjusted according to the demerit marks, to make the candlelight flicker, thereby awakening the user to a sense of lack of his/her wholeheartedness. If the demerit marks are beyond the limit, which is a mark of lack of wholeheartedness, the candle may be blown out by a gale even before the fixed period.

The present invention provides a method for realizing a burning candle on the Internet space, comprising the steps of a) transmitting a web page to a user so that the user can select the kind and pattern of a candle and input data including the opening and closing dates of the candle, b) generating a database based on the user's input data, c) extracting a candle corresponding to the database and transmitting the candle to the user, d) lighting the candle, e) burning down the candle as time elapses, and f) extinguishing the candle.

### BRIEF DESCRIPTION OF THE DRAWINGS

The above objectives and advantages of the present invention will become more apparent by describing in detail a preferred embodiment thereof with reference to the attached drawings in which:

FIG. 1 is a diagram of a web page showing fields in which data is to be input by a user;

FIG. 2 is a block diagram showing the embodiment of a server system and a user system according to the present invention;

FIG. 3 shows an example of a management database;

FIG. 4 shows an example of a web page transmitted to a user based on the user's input database;

FIG. 5 is a flow diagram of a method of realizing a burning candle on the Internet space according to the present invention; and

FIG. 6 is a flow diagram of a candle management procedure when a user connects to a server after lighting a candle on the Internet space.

### DESCRIPTION OF THE PREFERRED EMBODIMENT

The present invention will now be described in detail with reference to the accompanying drawings.

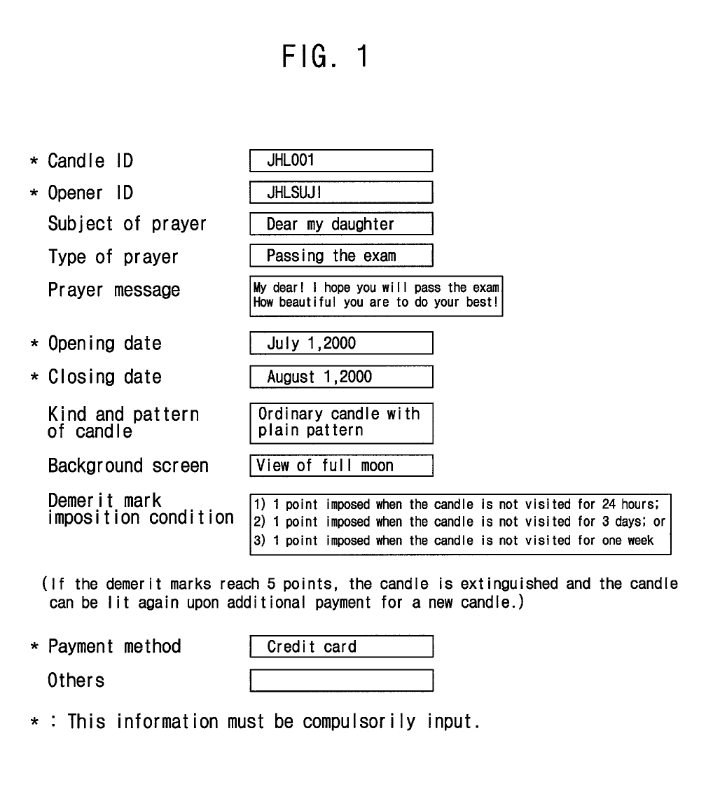

FIG. 1 is a diagram of a web page showing fields in which data is to be input by a user. The fields of data to be input by a user include but not limited to:

1) Field of candle ID;

2) Field of opener ID;

3) Field of subject of prayer;

4) Field of prayer type, e.g., celebration, condolence or prayer;

5) Field of prayer message;

6) Field of opening and closing dates of candle, for determining the duration of candle;

7) Field of candle pattern and kind, i.e., golden candle, silver candle, white candle or various designs;

8) Background screen;

9) Demerit mark imposition condition; and

10) Payment method

In the present invention, the above-described items of fields are not necessarily input. It would be apparent to those skilled in the art belonging to the field of subject that prayer, prayer type, prayer message or the like can be optionally input, and the fields of the pattern and kind of candle can be automatically set to certain ones.

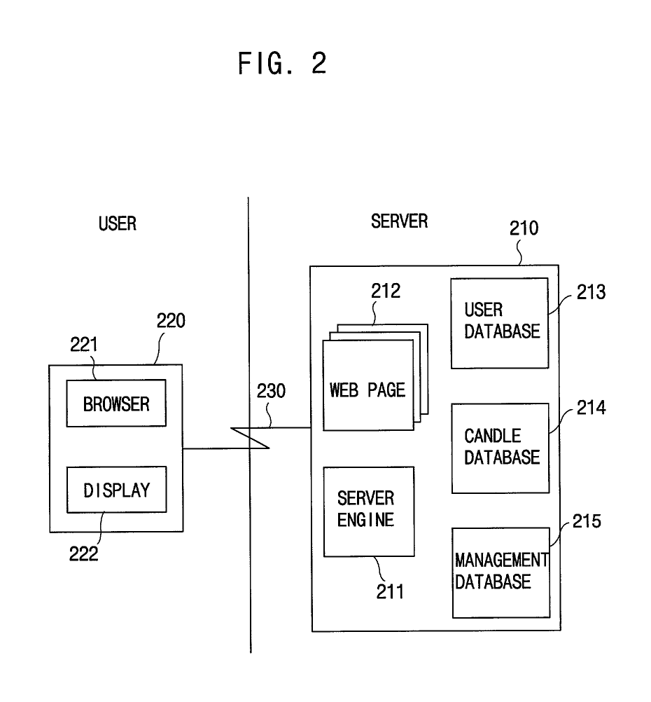

FIG. 2 is a block diagram showing the embodiment of a server system and a user system according to the present invention. A candle is ordered using the World Wide Web (WWW) over the Internet. The server system 210 includes a server engine 211, a variety of web pages 212, a user database 213, a candle database 214 and a management database 215.

If the user (computer) system 220 designates a URL (Uniform Resource Locator) and connects to the server system 210, the server engine 211 transmits the web pages 212 to multiple users. The user database 213 includes a variety of information on users, including opener ID, opener name, opener password, charging information, approval information or combinations thereof.

The candle database 214 includes data of candle, including candle kind, design and price. If necessary, the user can modify the kind and/or design of candle provided by the site operator. In this case, the candle database 214 of the server system 210 can be upgraded.

The management database 215 for managing the data input by the candle opener, includes candle ID, opener ID, subject of prayer, prayer type, prayer message, candle opening date, candle closing date, last visit time, demerit marks, kind and pattern of candle currently in use, payment method, deposit information and so on.

The user system 220 includes a host 221 and a display device 222. The host 221 includes a browser for performing browsing. The server system 210 and the user system 220 exchange information via a communication link 230.

Although it has been described that the candle is ordered over the Internet, it will be apparent to those skilled in the art that the invention can be applied to environments other than the Internet. For example, a method for ordering a candle can be applied to various kinds of communication channels such as LAN (Local Area Network) or WAN (Wide Area Network).

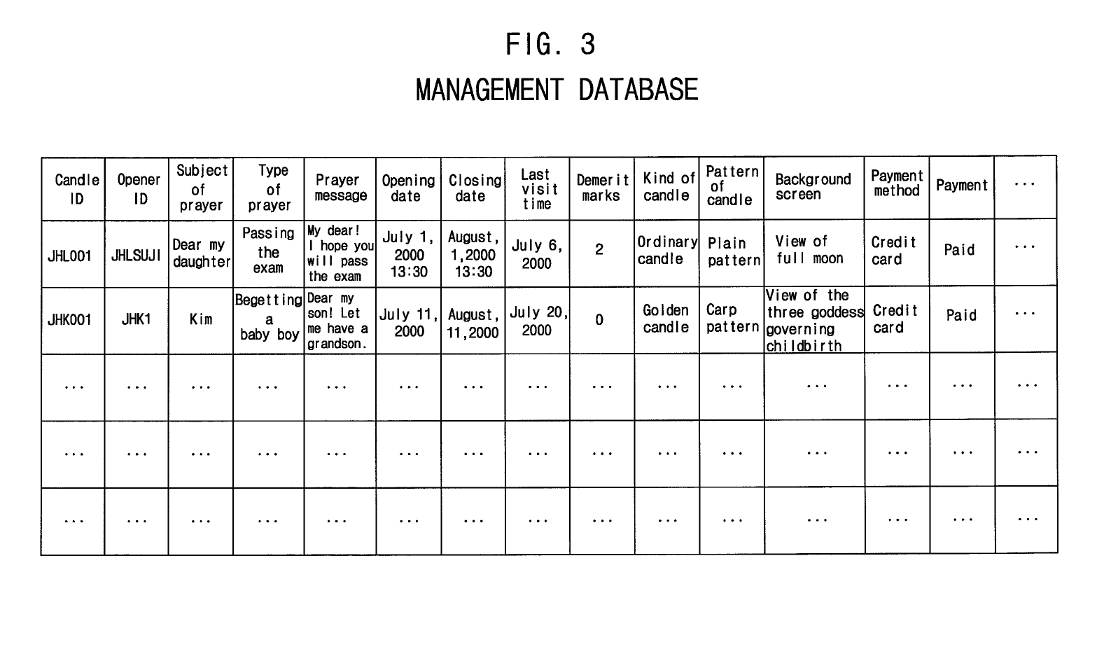

FIG. 3 shows an example of a management database. The management database includes candle ID, opener ID, subject of prayer, prayer type, prayer message, candle opening date, candle closing date, last visit time, demerit marks, kind and pattern of candle currently in use, payment method, deposit information and so on. If the user inputs a candle ID already registered in the server system, a server engine extracts a variety of information corresponding to the input candle ID from the management database and then transmits the extracted information to a user. The user can identify opener, general candle data and current status, e.g., last visit time, based on the received information. If the user is the opener, by inputting the user ID, all of the candles ID corresponding to the opener ID (or user ID) can be shown to the user, and the user can perform integrated management.

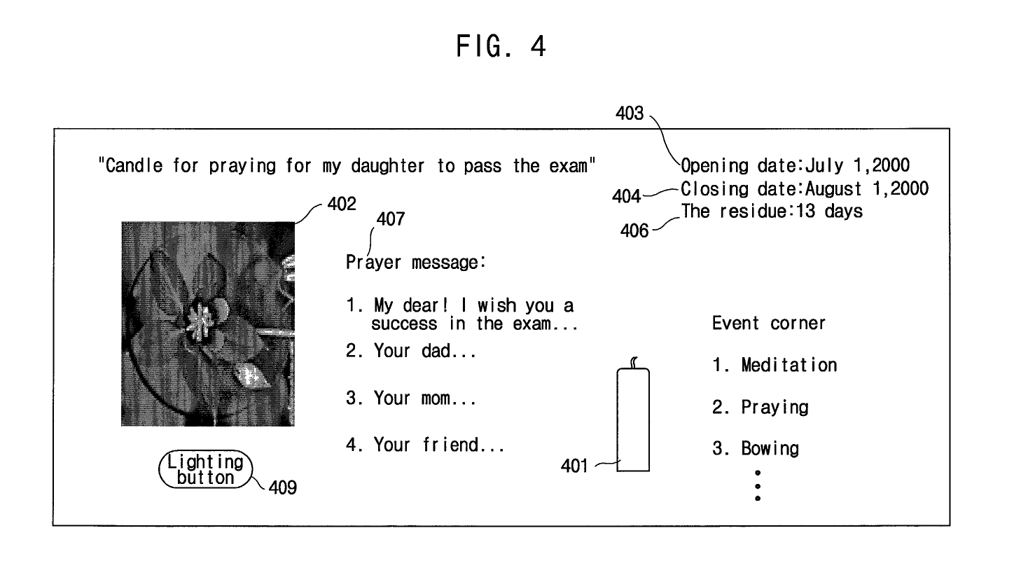

FIG. 4 shows an example of a web page transmitted to a user based on the user's input database. The web page includes a user's ordered candle 401, a background screen 402 for creating an elevated mood, an opening date 403, a closing date 404, the residue 406, a prayer message 407 containing words of encouragement, various kinds of ceremonies and events, e.g., meditation, praying or bowing. A candle can be automatically lit under the control of a server on the opening date. Alternatively, in order to induce user's interest and satisfy user's desire, a lighting button 409 may be further installed, and a candle can be lit by clicking on the lighting button 409. In the latter case, the server may resets the opening date and closing date of the candle based on the lighting time of the candle. The candle 401 gradually burns down for a fixed period until it is extinguished after the lapse of the fixed period. In the case where the user orders a candle for 30 days, the candle can be adjusted to be gradually reduced one thirties (1/30) a day. But this can reduce the reality. Thus, the candle is preferably set to burn down in real-time based on data of the opening date, the closing date and the current time.

However, if a prayer (user) is not wholehearted in taking care of the candle, that is, if the candle is not visited often, the demerit marks can be increased so that the candlelight may be compromised by strong wind. If the user does not visit the candle in a predetermined time, e.g., 5 consecutive days, that is, the demerit marks are greater than 5 points, the candlelight may be extinguished even before the closing date, for example, by a virtual gale. It would be quite natural of people to think that extinguishing the candle would cause the pray to be ineffective. In this case, the candle can be lit again by additionally paying for a new candle.

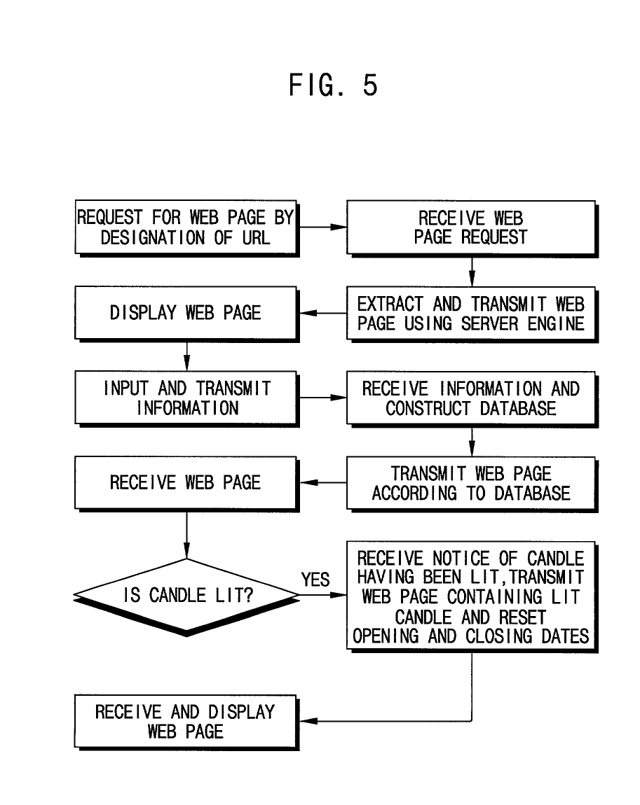

FIG. 5 is a flow diagram showing a method of realizing a burning candle on the Internet space according to the present invention. If a user system specifies a URL for a server system and request for a web page, the server system receives the request and transmits the web page as shown in FIG. 1 using a server engine. The user system receives and stores the web page and then displays it on a display device. Then, the user inputs information on various fields and transmits the input information to the server system. The server system extracts and constructs a database based on the transmitted information. The web page shown in FIG. 4, including a variety of additional information, e.g., burning candles, is transmitted to the user system based on the database. The user clicks on a lighting button to light the candle. The lit candle is gradually burnt down until it is extinguished on the closing date.

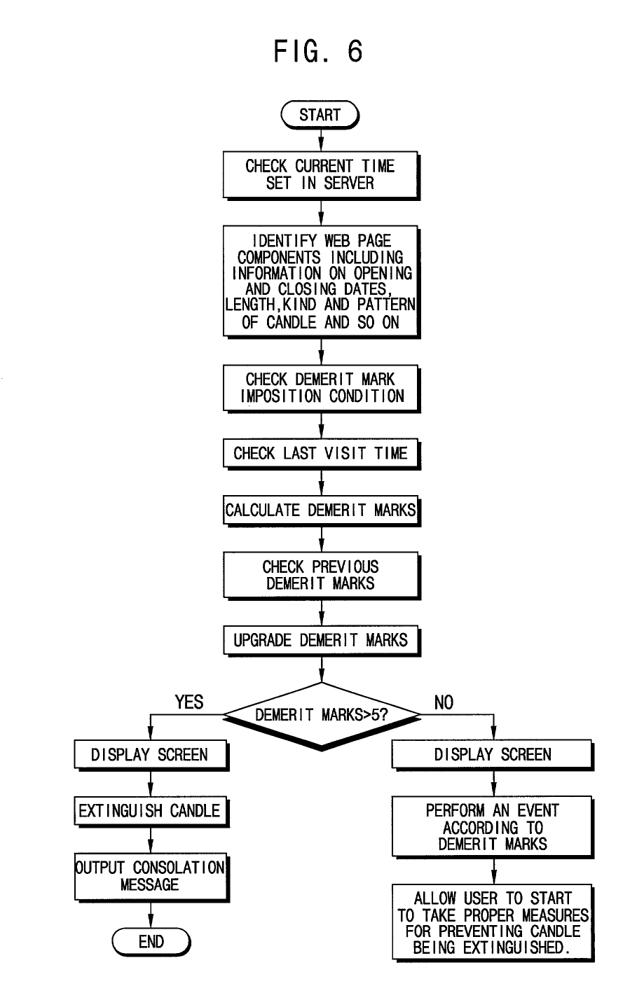

FIG. 6 is a flow diagram showing a candle management procedure when a user connects to a server after lighting a candle on the Internet space.

If the user connects to the server, the server checks the current time and identifies web page components including the opening date, closing date, residue, length of a candle, background screen and so on, checks demerit mark imposition condition and last visit time to calculate demerit marks, and checks previous demerit marks to be updated. If the demerit marks are greater than 5 points, a screen alerting that the demerit marks exceed the limit is displayed and the candle is then extinguished, followed by outputting a consolation message. If the demerit marks are less than 5 points, a screen informing of the current demerit marks is displayed and an appropriate event for the demerit marks is carried out so that the user starts to take a proper measure for not extinguishing the candle.

While the candle is established in the Internet space, a variety of additional events including meditation using an avatar (or a virtual entity featuring a cyber character), praying, bowing and so on can be provided. Also, in the case where the extinguishments of candle was not confirmed by the user on the closing date, an event in which the candle is extinguished at a later visit time may be further provided.

As described above, the present invention is fundamentally directed to a personal event, as can be exemplified by purchasing a candle for a praying purpose and wholeheartedly taking care of the candle. However, the applicability of the present invention can be extended to a candle for a couple, e.g., a wedded couple or a pair of lovers, a friendship candle for friends, e.g., alumni association or friendly society, or a group candle for organizations or groups. In particular, the group candle can also be lit by the operator for the public good with national praying incarnated therein, for example, a candle for praying for unification or a candle for praying for Korea to advance to the quarterfinals in the World Cup Football game. A candle for entertainer(s) or star player(s) serves as a part of fan club activity. During the period of an electoral campaign, political parities can use the inventive candle as a tool for checking the public opinion.

Some parts of sales money for the inventive business model can be utilized as the fund for the public good, e.g., subscriptions to relieve the flood victims, and some parts can be utilized to offer various kinds of premiums. Among various kinds of praying, a girl's praying for her mother's health recovery, praying of a child in a distant island to earnestly desire of taking an airplane and so on, are carefully screened as candidates for premium. The praying made by the most excellent candidate who manages the candle best for a month, can be realized as the premium. This is a kind of social interdependence, that is, the person who has realized his/her earnest desire will help others realize their earnest desires.

As described above, the business model proposed in the present invention that has ensured revenue and renders social welfare service can be appropriately applied on the Internet space.

In the method for realizing burning candles on the Internet space according to the present invention, candles incarnating hope or desire are purchased with payment, rather than free of charge, thereby creating revenue based on the sales of the candles, solving the revenue problem with existing electronic businesses. Also, for a user who wants to pray for his/her earnest hope or desire but has no time to visit a place where votive candles are provided, a praying-purpose candle can be realized on the Internet. Further, the votive candle can be lit for the good of others and one can also identify that the candle is lit for one's own sake.

What is claimed is:

1. A method for realizing a burning candle on the Internet space, comprising the steps of:
a) transmitting a web page to a user so that the user can select the kind and pattern of a candle and input data including the opening and closing dates of the candle;
b) generating a database based on the user's input data;
c) extracting a candle corresponding to the database and transmitting the candle to the user;
d) lighting the candle;
e) burning down the candle as time elapses; and
f) extinguishing the candle.

2. The method according to claim 1, wherein the step d) is automatically performed by a server or is performed by the user's clicking on a lighting button.

3. The method according to claim 1, wherein the step e) is performed in realtime.

4. The method according to claim 1, further comprising the step of extending the closing date by a payment of the additional fee.
